(19) United States
(12) Patent Application Publication
(10) Pub. No.: US 2012/0037036 A1
(43) Pub. Date: Feb. 16, 2012

(54) Dispersants and the process for preparing them

(75) Inventors: Thomas Veit, Hagen (DE); Frank Kleinsteinberg, Alpen (DE); Jochen Mergenthaier, Essen (DE); Stefanie Redeker, Wuppertal (DE); Anja Christofzik, Bochum (DE); Andre Brötzmann, Gelsenkirchen (DE); Phillippe Favresse, Ratingen (DE); Martin Glos, Borken (DE); Frank Schubert, Neukirchen-Vluyn (DE)

(73) Assignee: EVONIK GOLDSCHMIDT GMBH, Essen (DE)

(21) Appl. No.: 13/205,834

(22) Filed: Aug. 9, 2011

(30) Foreign Application Priority Data
Aug. 10, 2010 (DE) 10 2010 039 140.9

(51) Int. Cl. C09D 11/02; C09D 7/12; C08K 5/521; C07F 9/09

(52) U.S. Cl. 106/31.13; 558/186; 106/287.23; 106/503

(57) ABSTRACT

The present invention provides compounds which are liquid at a temperature of 20° C. and a pressure of 101325 Pa and are of the general formula (I) [R—O(SO)ₐ(EO)_{b}(CH₂CHCH₃O)_{c}(BO)_{d}]ₓ—[PO—(OH)₃₋ₓ]_{y}—R⁴_{z}, where R=cardanol radical, R⁴=H, M⁺ or alkyl having 1 to 3 C atoms, SO=styrene oxide, EO=ethylene oxide, BO=butylene oxide and a=0 to 3, b=0 to 100, preferably at least 1, c=0 to 20, d=0 to 3, x=1 to 3, y=0 or 1, with the proviso that y+z is =1, that if z=1 also x is =1, that when a, c and d are =0, b is from 1 to 15, preferably from 6 to 10, that when c or d is other than 0, one of the other indices a to d is likewise other than 0, and that the sum a+b+c+d is greater 3, a process for preparing them, compositions comprising these compounds, and the use thereof.

Any foregoing applications [including German patent application DE 10 2010 039 140.9, filed on 10 Aug. 2010, and all documents cited therein or during their prosecution (“application cited documents”) and all documents cited or referenced in the application cited documents, and all documents cited or referenced herein (“herein cited documents”), and all documents cited or referenced in herein cited documents, together with any manufacturer's instructions, descriptions, product specifications, and product sheets for any products mentioned herein or in any document incorporated by reference herein, are hereby incorporated herein by reference, and may be employed in the practice of the invention.

The present invention relates to phenolic compounds which are obtained by alkoxylation, optionally contain styrene oxide and are optionally phosphated, these compounds being summarized by the collective term cardanol or Cashew Nut Shell Liquid (CNSL), and to their use as additives, more particularly as dispersants in aqueous pigment pastes, for aqueous coating materials and printing inks, and also to processes for preparing them.

The use of cardanols has been known for many decades. For instance cardanol polymerized via the unsaturated side chain, and after subsequent formylation to form a cardanol-formaldehyde resin, is used in the form of friction particles in automotive brakes, since the temperature-dependent coefficient of friction between the resin used and the asbestos of the brakes is stabilized through using cardanol-formaldehyde resins, thereby enabling uniform braking (see inter alia U.S. Pat. No. 2,686,140, U.S. Pat. No. 3,227,249, FR 1573564 (U.S. Pat. No. 3,448,071), U.S. Pat. No. 4,072,650).

Cardanol is likewise described for the preparation of medicinally active substances such as phosphodiesterase inhibitors (P. P. Kumar; R. Paramashivappa; P. J. Vithayathil, P. V. Subba Rao, A. Srinivasa Rao, J. Agric. Food Chem 50 (2002) 4705), glyceraldehyde-3-phosphate dehydrogenase inhibitors (Junia M. Pereira, Richele P. Severino, Paulo C. Vieira, Joao B. Fernandes, M. Fatima G. G. da Silva, Aderson Zottis, Adriano D. Andricopulo, Glaucius Oliva, Arlene G. Correa, Bioorganic & Medicinal Chemistry 16 (2008) 8889), calcium antagonists (P. P. Kumar, Stefanie C. Stotz, R. Paramashivappa, Aaron M. Beedle, Gerald W. Zamponi, A. Srinivasa Rao, Molecular Pharmacology 61 (2002) 649) or antibiotics (WO 2008062436, US 2010016630).

Cardanol, furthermore, is reacted in a Mannich reaction with formaldehyde and amines such as ethylenediamine or diethyltriamine to form phenalkamines. Phenalkamines have entered the art, by virtue of the lower cure temperature as compared with the use of polyamides, as curing agents in the production of marine coatings and adhesives, of solvent-free floor coatings, for coatings on agricultural equipment, and for tank linings and pipe linings. They offer high resistance to moisture in the course of curing, and both good chemical resistance and elasticity (see inter alia R. A. Gardine, Modern Paint and Coatings 68 (1978) 33; P. H. Gedam, P. S. Sampathkumaran, Progress in Organic Coatings 14 (1986) 115; B. S. Rao, S. K. Pathak, Journal of Applied Polymer Science 100 (2006) 3956; J.-L. Dallons, European Coatings Journal 6 (2005) 34, US 2004048954, U.S. Pat. No. 5,075,034). More recently, cardanol-based curing agents prepared by hydrosilylation have also become known (US 2008275204). Cardanol-based phenolic resins serve as eco-friendly, acid-resistant anti-corrosion coatings (CN 101125994); the chemical and mechanical properties of coatings have been improved by chemically modified cardanol. (A. I. Aigbodion, C. K. S. Pillai, I. O. Bakare, L. E. Yahaya, Paintindia 51 (2001) 39; V. Madhusudhan, B. G. K. Murthy, Progress in Organic Coatings 20 (1992) 63; M. Yaseen, H. E. Ashton, Journal of Coatings Technology 50 (1978), 50).

For the reliable dispersing and stabilizing of pigments in coating systems it is general practice to use dispersants in order thereby to reduce the mechanical shearing forces needed for effective dispersing of the solids, and at the same time to realise very high degrees of filling. The dispersants assist the disruption of agglomerates; as surface-active materials they wet and cover the surface of the particles to be dispersed, and stabilize them against unwanted reagglomeration. The stabilizing of the pigments is of great importance in the coatings industry, since pigments, as an important formulating ingredient, determine the optical appearance and the physicochemical properties of a coating. In order that they may optimally develop their effect in the coating, they must be distributed uniformly and in a finely divided state in the coating material during the dispersing operation. The distribution must be stabilized, in order that this condition is retained in the course of preparation, storage, processing and subsequent film formation. Any reuniting of the primary particles and aggregates may lead to sedimentation, increase in viscosity, losses of gloss, inadequate depth of colour, low opacity, floating and flooding of the pigments, and poorly reproducible colour shades (Goldschmidt, Streitberger; BASF Handbuch Lackiertechnik, BASF Münster and Vincentz Verlag Hannover 2002, p. 205 ff).

A multiplicity of different substances nowadays find use as dispersants for solids. Alongside very simple compounds of low molecular mass, such as lecithin, fatty acids and their salts, for example, fatty alcohol alkoxylates (J. Bielmann, Polymers Paint Colour Journal 3 (1995) 17) and polymers (Frank O. H. Pirrung, Peter H. Quednau, Clemens Auschra, Chimia 56 (2002) 170) are also described for use as dispersants. Para-alkylphenol ethoxylates may likewise be used as dispersing additives for pigment pastes (J. Bielmann, Polymers Paint Colour Journal 3 (1995) 17). They are considered optimum dispersing additives, being notable for their low price as well as the performance. On ecotoxicological grounds, however, they have come under criticism because of their oestrogenic behaviour (A. M. Soto, H. Justicia, J. W. Wray, C. Sonnenschein, Environ Health Perspect 92 (1991) 167). Also discussed in connection with nonylphenol ethoxylates is the similarity of nonylphenol to the female sex hormone 17-β-oestradiol. Intervention of such degradation products in the fertility cycles of fish and mammals is considered to have been demonstrated (C. A. Staples, J. Weeks, J. F. Hall, C. G. Naylor, Environmental Toxicology and Chemistry 17 (1998) 2470; A. C. Nimrod, W. H. Benson, Critical Reviews in Toxicology, 26 (1996) 335). Consequently, in many countries their use in detergents is already prohibited. Similar prohibition is to be expected for the paints and printing inks industry.

As an alternative to the use of para-alkylphenol alkoxylates, patent applications EP 1167452 (U.S. Pat. No. 6,678,731) and EP 0940406 (U.S. Pat. No. 6,310,123) present the use of polyalkylene oxides containing styrene oxide and having a straight-chain or branched or cycloaliphatic starter compound, which are reacted by subsequent phosphorylation to form the corresponding phosphoric esters. The raw materials for the polyalkylene oxides described therein, however, are exclusively petroleum-based raw materials, which do not take any account of the general desire for more sustainability, in the coatings industry as well (S. Milmo, Coatings Comet 17 (2009) 10; T. Wright, Coatings World 4 (2008) 46; Robson F. Storey. The Waterborne Symposium, Advances in Sustainable Coatings Technology, Proceedings 2008 465)).

Ethoxylated, cardanol-based surfactants as dispersing additives for water-based pigment preparations, printing inks and coating materials are already known from U.S. Pat. No. 7,084,103. At common processing temperatures, however, the structures described therein are solid, and this is a disadvantage with regard to technical application by the industrial user.

For the user, however, emulsion paints harbour a number of disadvantages. For instance, when emulsion paints are used outdoors, on a façade which has only been relatively freshly coated, exposure to rain, even only for a short time, may be accompanied by the formation of shiny areas on the façades, often also referred to as “snail trails” due to their appearance. Emulsion paints always include water-soluble constituents, such as emulsifiers in the binder, thickeners and wetting agents, for example. These are technically vital for preparation, shelf life and processing. In the course of drying of a freshly applied coating, these additives, depending on the absorbency of the substrate in question and on the prevailing drying conditions, are partly absorbed into the substrate, but partly also migrate to the surface of the coating film, where they form a “deposit”. If it then rains, even briefly, on the façade, especially after a relatively limited drying time, or if other unfavourable weathering conditions are experienced, then the water-soluble constituents are dissolved again and, even after re-drying, remain as shiny areas in droplet form or in streaks until more prolonged rainfall washes the façade virtually “clean”. The quality properties of the coating are not adversely altered by the washing-out of the water-soluble fractions. However, the optical appearance of a freshly coated façade is significantly clouded.

Another important factor for coatings is the water swellability. This refers to the capacity of a coating to absorb water and give it off again later. Rapid water swellability and hence high water absorption are generally detrimental to the substrate. However, the coating system must also not be completely unswellable, since otherwise the coating would be lifted from the substrate as a result of formation of blisters on exposure to moisture (Zorll, Römpp Lexikon Lacke and Druckfarben, Thieme Verlag Stuttgart New York 1998, p. 625).

A further important criterion for a high-quality paint is its cleanability. This quality is measured as “wet abrasion resistance” and is the measure of the resistance of a coating to mechanical abrasion, as when cleaning the surface, for example.

It was an object of the present invention, therefore, to provide dispersing additives which can be processed easily, which are based preferably on renewable raw materials, which are suitable more particularly for use in aqueous pigment pastes for tinting aqueous paints and printing inks, and which preferably also reduce the formation of snail trails, lower the water swellability and/or improve the wet abrasion resistance.

Surprisingly it has been found that this object is achieved by compounds of the formula (I) which are liquid at a temperature of 20° C. and a pressure of 101325 Pa.

The present invention accordingly provides compounds of the formula (I) which are liquid at a temperature of 20° C. and a pressure of 101325 Pa, a process for preparing them, compositions which comprise one or more of the compounds of the invention, and the use of the compounds and of the compositions as additives, more particularly as dispersing additives, preferably for aqueous pigment systems.

The compounds of the invention or mixtures thereof have the advantage that at a temperature of 20° C. and a pressure of 101325 Pa they are present in the form of liquids and can therefore be processed very easily. Particularly if the compounds of the invention are also still miscible with the liquid phase of the pigment system, preferably water, the compounds of the invention can be mixed substantially more easily and uniformly into the pigment system than is the case when using additives which are present in the form of solids.

By virtue of the liquid aggregated state of the compound, the compounds of the invention as dispersing additives are more easily able to attach uniformly to the surface of the pigments and so fulfil their function.

The use of the compounds of the invention as dispersants has the advantage, moreover, that, in comparison to additives of the prior art, lower rub-out values and higher colour values are achieved. A further advantage of the use of the compounds of the invention is that pigment pastes prepared accordingly have a long shelf life.

The compounds of the invention, compositions comprising them, a process for preparing them, and the use of the compounds/compositions of the invention, are described below by way of example, without any intention that the invention should be confined to these exemplary embodiments. Where ranges, general formulae or classes of compound are indicated below, the intention is that they should encompass not only the corresponding ranges or groups of compounds that are explicitly mentioned, but also all sub-ranges and sub-groups of compounds which may be obtained by extraction of individual values (ranges) or compounds. Where documents are cited in the context of the present invention, the intention is that their content should belong in full to the disclosure content of the present invention. Where figures in percent are given below, these figures, unless otherwise indicated, are figures in percent by weight. Where average values are specified below, the values in question, unless otherwise indicated, are numerical averages.

The compounds of the invention which are liquid at a temperature of 20° C. and a pressure of 101325 Pa, or liquid mixtures consisting of compounds of the formula (I), are distinguished by the fact that the compounds conform to the general formula (I)

[R—O(SO)ₐ(EO)_{b}(CH₂CHCH₃O)_{c}(BO)_{d}]ₓ—[PO—(OH)₃₋ₓ]_{y}—R⁴_{z} (I),

where

### R=

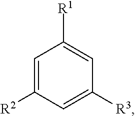

R¹=bond to the unit —O(SO)ₐ(EO)_{b}(CH₂CHCH₃O)_{c}(BO)_{d}—,
R²=H or —O(SO)ₐ(EO)_{b}(CH₂CHCH₃O)_{c}(BO)_{d}—[PO—(OR⁶)_{2-x′}(R⁵)_{x′}]_{y′}—R⁴_{z′}, preferably H,
R³=identical or different, saturated or unsaturated aliphatic hydrocarbon radical having 15 carbon atoms and 25 to 31 hydrogen atoms,
R⁴=identically or differently, H, M⁺ or alkyl radical having 1 to 3 C atoms,
R⁵=organic radical,
R⁶=identically or differently H or M⁺,
M⁺=metal or semi-metal cation, preferably a silicon, an aluminium, an alkali metal or alkaline earth metal cation,
SO=styrene oxide,
EO=ethylene oxide,
BO=butylene oxide, and
a=0 to 3, preferably 0, 1 or 2, more preferably 0 or 1,
b=0 to 100, preferably at least 1, more preferably 1 to 20, very preferably 6 to 12,
c=0 to 20, preferably 0 or 1 to 5,
d=0 to 3, preferably 0 or 2 or 3,
x=1 to 3, preferably 1 or 2, more preferably 1,
y=0 or 1, preferably 1,
z=0 or 1, preferably 0,
y′=0 or 1, preferably 0,
z′=0 or 1, preferably 1, and
x′=0 to 2, preferably 1,
with the proviso that y+z is =1, that when z=1, also x is =1, that y′+z′=1, that when z′=1, also x′ is =1, that when a, c and d are =0, b is from 1 to 12, preferably from 6 to 10, that when c or d is other than 0, one of the other indices a to d is likewise other than 0, and that the sum a+b+c+d (per unit —O(SO)ₐ(EO)_{b}(CH₂CHCH₃O)_{c}(BO)_{d}— present) is greater than 3.

The different monomer units of the building blocks indicated in the formula (I) may be of blockwise construction with one another, with an arbitrary number of blocks, and may be subject to an arbitrary sequence or to a statistical distribution. The indices used in the formulae are to be considered as statistical average values (numerical averages).

The radical R³ may be a fully saturated hydrocarbon radical or a singly, doubly or triply unsaturated hydrocarbon radical. Where the compounds of the formula (I) comprise a mixture of compounds, said mixture may comprise exclusively those compounds of the formula (I) in which R³ is in each case identical or in which the radicals R³ are different. Preferred compounds of the formula (I) are those whose radical R is derived from a decarboxylated anacardic acid, a mixture of (Z,Z)-6-(pentadecanyl)salicylic acids obtainable from the shell of the cashew nut, with 0 to 3 double bonds in the side chain. Particularly preferred compounds of the formula (I) are those in which, of the radicals R³, 35 to 45 mol %, preferably approximately 42 mol %, are triply unsaturated, 30 to 40 mol %, preferably approximately 34 mol %, are doubly unsaturated, 15 to 25 mol %, preferably approximately 22 mol %, are singly unsaturated, and 0 to 5 mol %, preferably approximately 2 mol %, are saturated.

Through the respective number of the units having the indices a to d it is possible to exert specific control over the HLB value. Moreover, steric requirements of the pigment surface may be taken into account where appropriate. Through the number of the respective units it is possible, moreover, to tailor the compatibility of the compounds with the respective pigment system.

Particularly preferred compounds of the formula (I) are those in which b is other than 0, preferably 6 to 20, more preferably 6 to 12. By including a certain minimum fraction of ethylene oxide units it is possible to ensure that the compounds of the formula (I) are water-soluble or are miscible with water in any proportion without forming a second phase.

Particularly preferred compounds are those in which R²═H, y=1 and z is =0, and preferably x is =1.

The units denoted with the indices a, b, c and/or d may be statistically distributed or arranged blockwise. The units denoted with the indices a, b, c and/or d are preferably arranged blockwise.

It can be advantageous if the last unit of the units with the indices a, b, c and d, in other words the unit the furthest removed from the radical R and hence having a bond to the phosphorus or to R⁴, is an ethylene oxide unit.

Preferred compounds of the formula (I) are those which have exclusively units of the indices a and b. Particularly preferred compounds are those which, counting from cardanol radical R as starting alcohol, have first an ethylene oxide block (B1), then a propylene oxide block (A) and finally an ethylene oxide block (B2) again, with preference being given to those compounds in which the ethylene blocks B1 and B2 have in each case from 3 to 8, preferably 6, ethylene oxide units and the propylene oxide block A has from 2 to 4, preferably 2, propylene oxide units. In the case of these preferred compounds of the formula (I), it is additionally preferred if the radical R² is a hydrogen.

It can be advantageous if some or all of the radicals R⁶, preferably all, are M⁺, more particularly alkali metal cations.

The skilled person is well aware that the compounds of the formula (I) are present typically in the form of a mixture of these compounds having a distribution governed essentially by laws of statistics. The indices indicated, in the event of the presence of a mixture of compounds of the formula (I), represent the numerical average in each case.

The compounds of the invention can be obtained in a variety of ways. The compounds of the invention and mixtures thereof are preferably prepared by the process of the invention, which is described below.

The process of the invention for preparing compounds of the invention or mixtures thereof is distinguished by the fact that it comprises the steps of

A) activating a starter compound containing OH groups with a suitable acidic, basic or DMC catalyst (double metal cyanide catalysts),
B) reacting the compounds obtained in step A) with aliphatic and/or aromatic alkylene oxides, the aliphatic and/or aromatic alkylene oxides being used in molar amounts such that the indices a, b, c and d, more particularly those described as indices a to d in the preferred embodiments, indicated in formula (I) are obtained,
C) optionally reacting the compound obtained in step B) with a phosphorus compound which forms phosphoric esters, and
D) optionally reacting the compound obtained in step C) with a neutralizing agent.

It can be advantageous if a neutralizing step E) is carried out between steps B) and C).

### Step A)

As catalysts it is possible to employ all of the catalysts that are known from the prior art.

Acidic catalysts which can be used include, for example, the acidic catalysts described by DE 10 2004 007561 (US 2007185353). As acidic catalysts it is preferred to use halogen compounds of the elements of main groups IIIA and IVA of Periodic Table of the Elements, more particularly of the elements B, Al and Sn. Used with particular preference as acidic catalysts are HBF₄, BF₃, AlCl₃ or SnCl₄.

Examples of basic catalysts which can be used with preference are alkali metal hydroxides and alkali metal methylates, such as potassium hydroxide or sodium methylate, for example. Potassium methylate is used with particular preference as basic catalyst in step A).

As DMC catalysts, it is possible, for example, to use the DMC catalysts described in DE 102007057146 (US 2009137752) and the literature cited therein. Preference is given to using DMC catalysts which comprise zinc and cobalt, preferably those which comprise zinc hexacyanocobaltate(III). It is preferred to use the DMC catalysts described in US 5158,22, US 20030119663 or WO 01/80994 (U.S. Pat. No. 6,835,687). The DMC catalysts used may be amorphous or crystalline.

The catalyst concentration in the reaction mixture, especially that of the DMC catalysts, is preferably >0 to 10 000 wppm (ppm by mass), more preferably >0 to 2500 wppm, very preferably 0.1 to 200 wppm, and with particular preference 30 to 100 wppm. This concentration is based on the total mass of the reaction mixture.

The catalyst is preferably metered only once into the reactor. The amount of catalyst should be set such as to provide sufficient catalytic activity for the process. The catalyst may be metered as a solid or in the form of a catalyst suspension, preferably as a solid.

Used with particular preference in step A) are basic catalysts or DMC catalysts, more particularly those identified explicitly above.

As the OH-group-containing starter compound (starting alcohol) it is preferred to use one or more cardanols. The cardanols are preferably those obtainable by decarboxylation of anacardic acid, a mixture of (Z,Z)-6-(pentadecanyl)salicylic acids obtainable from the shell of the cashew nut, having 0 to 3 double bonds in the side chain. Particularly preferred cardanols are those in which the pentadecanyl radical is on numerical average 35 to 45 mol %, preferably approximately 42 mol %, triply unsaturated, 30 to 40 mol %, preferably approximately 34 mol %, doubly unsaturated, 15 to 25 mol %, preferably approximately 22 mol %, singly unsaturated, and 0 to 5 mol %, preferably approximately 2 mol %, saturated.

### Step B)

Step B) may be carried out in a manner known per se as described in the prior art. Step B) is preferably carried out, for example, as described in U.S. Pat. No. 3,427,256, U.S. Pat. No. 3,427,334, U.S. Pat. No. 3,427,335, U.S. Pat. No. 3,278,457, U.S. Pat. No. 3,278,458, U.S. Pat. No. 3,278,459, U.S. Pat. No. 5,470,813 or U.S. Pat. No. 5,482,908.

Step B) is carried out preferably at a temperature of 90 to 200° C., more preferably 100 to 150° C. and very preferably of approximately 120° C. The pressure at which step B) is preferably carried out is preferably from 101325 to 1013250 Pa, more preferably from 401325 to 801325 Pa and very preferably not more than 601325 Pa.

Step B) may take place in the presence of an inert solvent such as, for example, toluene, xylene, cyclohexane, tetrahydrofuran or ethylene glycol dimethyl ether, or in bulk. The reaction in step B) takes place preferably in bulk.

It can be advantageous if the reaction of the various aliphatic and/or aromatic alkylene oxides takes place in succession. In this way, the blockwise construction can be controlled in a simple manner.

### Step C)

Step C) may be carried out in bulk or in the presence of a solvent. Solvents which can be used include, in particular, aprotic organic solvents, such as hydrocarbons, for example. Toluene is a more preferred solvent used. Step C) is preferably carried out in bulk.

Step C) uses as phosphorus compound preferably a phosphorus compound selected from phosphoric acid, phosphoryl chloride and polyphosphoric acid (P₂O₅ in solution in H₃PO₄), more preferably phosphoryl chloride or polyphosphoric acid (P₂O₅ in solution in H₃PO₄) and very preferably polyphosphoric acid (P₂O₅ in solution in H₃PO₄). An example of a suitable polyphosphoric acid is the polyphosphoric acid identified by CAS No. 8017-16-1, with an 84% by weight content of P₂O₅ in solution in H₃PO₄, from Clariant.

The polyphosphoric acid is added preferably in amounts such that the molar ratio of OH groups of the polyether obtained in step B) to polyphosphoric acid, calculated as P₂O₅, is from 1:0.1 to 1:2, preferably from 1:0.2 to 1:1 and more preferably of 1:0.5.

Step C) is carried out preferably at a temperature of 40 to 150° C., more preferably 55 to 125° C. and very preferably from 70 to 110° C. The pressure at which step C) is preferably carried out is 101325 Pa.

### Step D)

As neutralizing agents it is possible in step D) to use, in particular, alkali metal hydroxides. As neutralizing agents in step D) it is preferred to use potassium hydroxide, preferably in the form of an aqueous solution. Particular preference is given to using in step D) an aqueous potassium hydroxide solution with a strength by weight of 20% to 30%.

In step D) it is preferred to add an amount of neutralizing agent such that the pH of the treated reaction mixture is from 8 to 9, preferably 8.5.

The pH is determined preferably in accordance with DIN EN 1262, using a pH meter with glass electrode, at a temperature of 20 to 25° C. One minute after a constant reading has been obtained, it is read off and the pH is recorded to an accuracy of one decimal place.

Step D) is carried out preferably at a temperature of 20 to 90° C., more preferably 40 to 80° C. and very preferably from 50 to 70° C. The pressure at which step D) is preferably carried out is 101325 Pa.

### Step E)

Depending on the catalyst used in step A) and/or B), it may be advantageous or necessary, respectively, to carry out a neutralizing step E) after step B).

If a basic catalyst is used as catalyst in step A) and/or B), then the neutralizing agent is preferably an acid such as lactic or phosphoric acid, more preferably lactic acid or an aqueous solution thereof.

If an acidic catalyst is used as catalyst in step A) and/or B), then the neutralizing agent is preferably a base, more preferably alkali metal hydroxide or alkali metal carbonate, very preferably NaOH or an aqueous solution or suspension thereof. Where aqueous solutions of the neutralizing agent are used, it can be advantageous, before carrying out step C), to carry out a process step in which water is separated off. The separation of the water may be accomplished by distillation, for example.

By means of the compounds of the invention, access is made possible to compositions of the invention which comprise at least one of the compounds of the invention. Besides the at least one compound of the formula (I) according to the invention, the compositions of the invention may comprise water or may consist of these components. Where the composition of the invention comprises water and compounds of the formula (I), the fraction of compounds of the formula (I) is preferably from 0.1% to 99.9% by weight, more preferably from 5% to 60% by weight, very preferably from 10% to 30% by weight, and the fraction of water is preferably from 0.1% to 99.9% by weight, more preferably from 40% to 95% by weight and very preferably from 70% to 90% by weight.

The composition of the invention may further comprise one or more auxiliaries such as, for example, defoamers, deaerating agents or preservatives, and one or more solids, more particularly pigments. A solid for the purposes of the present invention may in principle be any organic or inorganic material which is solid at a temperature of 20° C. and a pressure of 101325 Pa. The fraction of the compounds of the formula (I) according to the invention, based on the weight of the solids, preferably of the pigments, is preferably from 2.0% to 200% by weight, more preferably 5.0% to 100% by weight, very preferably from 10% to 30% by weight.

Examples of solids which may be present in the composition of the invention are, for example, pigments, fillers, dyes, optical brighteners, ceramic materials, magnetic materials, nanodisperse solids, metals, biocides, agrochemicals, and pharmaceuticals, which are employed as dispersions.

Preferred solids are pigments, such as are set out, for example, in the Colour Index, Third Edition, Volume 3; The Society of Dyers and Colourists (1982), and in the subsequent, revised editions.

Preferred examples of pigments are inorganic pigments, such as carbon blacks, titanium dioxide, zinc oxides, Prussian blue, iron oxides, cadmium sulphides, chromium pigments, such as, for example, chromates, molybdates and mixed chromates and sulphates of lead, zinc, barium, calcium and mixtures thereof. Further examples of inorganic pigments are given in the book by H. Endriss, Aktuelle anorganische Bunt-Pigmente, Vincentz Verlag, Hannover (1997).

Preferred examples of organic pigments are those from the group of the azo, disazo, condensed azo, naphthol, metal complex, thioindigo, indanthrone, isoindanthrone, anthanthrone, anthraquinone, isodibenzanthrone, triphenodioxazine, quinacridone, perylene, diketopyrrolopyrrole and phthalocyanine pigments. Further examples of organic pigments are given in the book by W. Herbst, K. Hunger, Industrial Organic Pigments, VCH, Weinheim (1993).

Further preferred solids are fillers, such as, for example, talc, kaolin, silicas, barites and lime; ceramic materials, such as, for example, aluminium oxides, silicates, zirconium oxides, titanium oxides, boron nitrides, silicon nitrides, boron carbides, mixed silicon-aluminium nitrides and metal titanates; magnetic materials, such as, for example, magnetic oxides of transition metals, such as iron oxides, cobalt-doped iron oxides and ferrites; metals, such as, for example, iron, nickel, cobalt and alloys thereof; and biocides, agrochemicals and pharmaceuticals, such as, for example, fungicides.

In the solids- and/or pigment-containing compositions of the invention, the compounds of the formula (I) may be used alone or in combination. For the preparation of these compounds, the compounds of the formula (I) according to the invention may either be mixed beforehand with the solids (pigments) to be dispersed, or dissolved directly in an aqueous dispersing medium before or simultaneously with the addition of the solids (pigments) and any further solids. In addition to the components stated, the compositions of the invention may comprise further additives and auxiliaries, more particularly other, conventional, pigment-wetting additives and/or resins.

The compounds of the formula (I) according to the invention may be used as additives, preferably as pigment wetting agents and/or dispersants. The compounds of the formula (I) according to the invention are used more preferably as additives for pigment pastes, varnishes, paints or printing inks, preferably as additives for corresponding aqueous (water-containing) products.

The compositions of the invention can be used for producing paints, varnishes and printing inks/printing varnishes, binder-containing or binder-free pigment pastes, or coating materials, or as paints, varnishes and printing inks/printing varnishes, binder-containing or binder-free pigment pastes or coating materials. The compositions of the invention are used preferably for producing corresponding aqueous or water-containing products, or as corresponding aqueous or water-containing products.

In the examples set out below, the present invention is described by way of example, without any intention that the invention, the scope of application of which is evident from the whole of the description and the claims, should be confined to the embodiments specified in the examples.

### EXAMPLES

### Example 1a

### Synthesis of Polyalkylene Oxide PAO1

303 g (1 mol) of cardanol and 2.7 g (0.05 mol) of sodium methylate were placed in a reactor. Following careful flushing with ultra-pure nitrogen, heating took place to 125° C. and 240 g (2 mol) of styrene oxide were added over the course of an hour. After a further 2 hours, the addition reaction of the styrene oxide was at an end, evident from a residual styrene oxide content of <0.1% by weight according to GC. Then 484 g (11 mol) of ethylene oxide were metered into the reactor at a rate such that the internal temperature did not exceed 125° C. and the pressure did not exceed 6 bar. Following complete introduction of the ethylene oxide, the temperature was held at 125° C. until a constant manometer pressure indicated the end of the subsequent reaction. Lastly, at 80° C. to 90° C., the unreacted residual monomers were removed under reduced pressure. The product obtained was neutralized using phosphoric acid, and the water was removed by distillation, and the sodium phosphate formed by filtration together with a filter aid.

### Examples 1b to 1f

### Synthesis of Polyalkylene Oxides PAO2 to PAO6

The compounds PAO2 to PAO6 were prepared in the same way as for Example 1a.

The molar amounts employed of the components used in Examples 1a to if can be taken from Table 1a (figures in mol).

TABLE 1a
Amounts of the raw materials used in Examples 1a to 1f (figures in mol).

| | | | Styrene | Ethylene | Propylene | Butylene | Aggregate |
|---|---|---|---|---|---|---|---|
| Example | Comp. | Cardanol | oxide | oxide | oxide | oxide | state* |
| 1a | PAO1 | 1 | 2 | 11 | 0 | 0 | liquid |
| 1b | PAO2 | 1 | 1 | 9 | 0 | 0 | liquid |
| 1c | PAO3 | 1 | 2 | 13 | 0 | 0 | liquid |
| 1d | PAO4 | 1 | 0 | 10 | 0 | 0 | liquid |
| 1e | PAO5 | 1 | 0 | 20 | 3 | 0 | liquid |
| 1f | PAO6 | 1 | 0 | 20 | 3 | 1 | liquid |

*At a temperature of 20° C. and a pressure of 101325 Pa

### Example 2a

### Synthesis of Phosphoric Ester A1

1 OH equivalent of the polyalkylene oxide PAO 1 was charged to the reactor and heated to 110° C. Through application of reduced pressure, all of the volatile fractions, and especially any water present in the product, were removed by distillation from the reaction space. Following admission of nitrogen, the batch was brought to 80° C. and polyphosphoric acid (CAS No. 8017-16-1; polyphosphoric acid 84%, purity calculated as P₂O₅ in solution in H₃PO₄, manufacturer: Clariant) was added in accordance with the OH equivalent. After 2 hours, the reaction is at an end; an aliphatic hydroxyl group was no longer detectable in the ¹H-NMR spectrum.

### Examples 2b to 2h

### Synthesis of Phosphoric Esters A2 to A8

Phosphoric esters A2 to A8 were prepared in the same way as for Example 2a. In the case of Examples 2g and 2h (compounds A7 and A8), there was no esterification.

Table 1b identifies the phosphoric esters obtained in more detail, with x, y, z and R⁴ having the definition indicated for formula (I).

TABLE 1b
Products obtained in Examples 2a to 2h on the basis of the
polyethers of Example 1 employed

| Compound | Polyether | X | y | z | R⁴ | Aggregate state* |
|---|---|---|---|---|---|---|
| A1 | PAO1 | 1 | 1 | 0 | — | liquid |
| A2 | PAO2 | 1 | 1 | 0 | — | liquid |
| A3 | PAO3 | 1 | 1 | 0 | — | liquid |
| A4 | PAO4 | 1 | 1 | 0 | — | liquid |
| A5 | PAO5 | 1 | 1 | 0 | — | liquid |
| A6 | PAO6 | 1 | 1 | 0 | — | liquid |
| A7 | PAO4 | 1 | 0 | 1 | H | liquid |
| A8 | PAO5 | 1 | 0 | 1 | H | liquid |

*At a temperature of 20° C. and a pressure of 101325 Pa

### Example 3

### Test of the Dispersing Properties

For the performance investigations described below, compounds A1 to A8 were diluted to a total solids content of 30% by weight with dilute aqueous 25% strength by weight potassium hydroxide solution, and this mixture was used as a dispersing additive. Solids selected were the following commercial pigments:
Heliogen Blue L7101F (BASF SE)
Permanent Red FGR 70 (Clariant)
Bayferrox 120M (Lanxess)

### Example 3.1

### Preparation of Pigment Pastes

The formula constituents were weighed out in accordance with the formulas indicated in Table 2 into 250 ml screw-top glass vessels, and glass beads were added (200 g of glass beads per 100 g of material for mixing). The sealed vessels were subsequently shaken in a Skandex mixer (model: DAS H 200-K from Lau GmbH) for 2 hours. The glass beads were subsequently separated from the pigment paste with the aid of a sieve (E-D-Schnellsieb 400μ, cotton mesh, medium, from Erich Drehkopf GmbH).

TABLE 2
Compositions of the pigment pastes

| | Heliogen Blue | Permanent Red | Bayferrox |
|---|---|---|---|
| | L7101F | FGR 70 | 120 M |
| H₂O, demin. | 12.7 g | 12.3 g | 18.0 g |
| Dispersing additive | 49.3 g | 46.7 g | 21.0 g |
| A1-A8 ^{a)} | | | |
| Foamex 8050 ^{b)} | 1.0 g | 1.0 g | 1.0 g |
| Pigment | 37.0 g | 40.0 g | 60.0 g |
| Sum total | 100 g | 100.0 g | 100 g |

^{a)} Active ingredient content 30% by weight
^{b)} Defoamer, trade name of Evonik Goldschmidt GmbH

For these pigment pastes, a determination was made of the viscosities at 23° C. and at both 300 and 1000 reciprocal seconds (rotary viscometer Anton Paar Physica MCR 301 with CP 50-2 measuring cone; 5 measurement points per shear rate, with subsequent averaging; 10 seconds' preliminary shearing per measurement point), both immediately and after four-weeks' storage at 50° C. of the pigment pastes from Example 3.1. The results of this test are reported in Tables 3a to 3c.

TABLE 3a
Test results of the pigment pastes based
on the pigment Heliogen Blue L7101F.

| | |
|---|---|
| Viscosity, mPas, | Viscosity, mPas, |
| immediate | 4 weeks, 50° C. |

| Heliogen | 300 | 1000 | 300 | 1000 |
|---|---|---|---|---|
| Blue L7101F | s⁻¹ | s⁻¹ | s⁻¹ | s⁻¹ |
| A1 | 752 | 418 | 792 | 467 |
| A2 | 710 | 422 | 812 | 479 |
| A3 | 793 | 519 | 893 | 551 |
| A4 | 821 | 436 | 921 | 482 |
| A5 | 756 | 534 | 868 | 574 |
| A6 | 828 | 415 | 928 | 457 |
| A7 | 710 | 425 | 836 | 471 |
| A8 | 723 | 437 | 853 | 471 |

TABLE 3b
Test results of the pigment pastes based
on the pigment Permanent Red FGR 70.

| | |
|---|---|
| Viscosity, mPas, | Viscosity, mPas, |
| immediate | 4 weeks, 50° C. |

| Permanent | 300 | 1000 | 300 | 1000 |
|---|---|---|---|---|
| Red FGR 70 | s⁻¹ | s⁻¹ | s⁻¹ | s⁻¹ |
| A1 | 345 | 289 | 411 | 315 |
| A2 | 382 | 278 | 443 | 332 |
| A3 | 341 | 275 | 373 | 308 |
| A4 | 365 | 259 | 365 | 297 |
| A5 | 377 | 244 | 377 | 291 |
| A6 | 305 | 289 | 305 | 334 |
| A7 | 321 | 299 | 321 | 364 |
| A8 | 319 | 279 | 319 | 326 |

TABLE 3c
Test results of the pigment pastes based
on the pigment Bayferrox 120 M.

| | |
|---|---|
| Viscosity, mPas, | Viscosity, mPas, |
| immediate | 4 weeks, 50° C. |

| Bayferrox | 300 | 1000 | 300 | 1000 |
|---|---|---|---|---|
| 120 M | s⁻¹ | s⁻¹ | s⁻¹ | s⁻¹ |
| A1 | 337 | 268 | 402 | 353 |
| A2 | 357 | 237 | 454 | 324 |
| A3 | 341 | 241 | 423 | 301 |
| A4 | 343 | 243 | 489 | 387 |
| A5 | 352 | 252 | 495 | 375 |
| A6 | 321 | 221 | 452 | 302 |
| A7 | 352 | 252 | 469 | 324 |
| A8 | 321 | 221 | 498 | 331 |

### Example 3.2

### Tinting of an Aqueous White Paint

An aqueous white paint based on a straight-acrylate dispersion (Neocryl XK 90, from DSM NeoResins) was used. The formula ingredients for the white paint were admixed with 200 g of glass beads, in accordance with the formula below from Table 4, and then shaken in a Skandex mixer (model: DAS H 200-K from Lau GmbH) for 1 hour. The glass beads were subsequently separated off by means of a sieve (E-D-Schnellsieb 400μ, cotton mesh, medium, from Erich Drehkopf GmbH).

TABLE 4
Composition of the test paint

| | Neocryl XK 90 |
|---|---|
| H₂O, demin. | 3.9 g |
| Tego Dispers 755 W ^{a)} | 9.0 g |
| Foamex 810 ^{b)} | 0.5 g |
| Parmetol K 40 ^{c)} | 0.1 g |
| Aerosil 200 ^{d)} | 0.1 g |
| Neocryl XK 90 ^{e)}/Texanol 97: 3 | 53.4 g |
| Tego Wet KL 245 ^{f)} | 0.5 g |
| Visko Plus 3000 ^{g)} | 1.0 g |
| Kronos 2310 ^{h)} | 31.5 g |
| Total | 100.0 g |

^{a)} Dispersant, Evonik Goldschmidt GmbH
^{b)} Defoamer, Evonik Goldschmidt GmbH
^{c)} Preservative, Schülke & Mayr
^{d)} Thixotropic agent, Evonik Degussa GmbH
^{e)} Polyacrylate dispersion, DSM NeoResins
^{f)} Substrate wetting agent, Evonik Goldschmidt GmbH
^{g)} Rheological additive, Evonik Goldschmidt GmbH
^{h)} White pigment (titanium dioxide), Kronos

To produce tinted paints, 1 g of each pigment paste from Example 3.1 and 20 g of white paint were weighed out together. The mixture was homogenised for 1 minute in a Speedmixer (model: DAC 150 FVZ from Hauschild & Co. KG) at 2500 rpm. The tinted test paints produced in this way were knife-coated using a wire-wound coating bar (100 μm) onto a contrast chart (Leneta®) and dried at room temperature. Colorimetry of the paint blend (100 μm film thickness on Leneta® contrast chart) took place using an instrument from X-Rite (model: X-Rite SP 60). After drying for 5 minutes, a rub-out test was carried out; the colorimetric values are reproduced as components of the CIE L*a*b* colour model (DIN 6174: “colorimetric evaluation of colour coordinates and colour differences according to the approximately uniform CIELAB colour space”).

The results of the colorimetry are summarized in Tables 5a to 5c.

TABLE 5a
Results of colorimetry for test paint tinted
with Heliogen Blue 7101F pigment paste.

| | Colour | | |
|---|---|---|---|
| Dispersing additive | strength F | b* | delta E |
| A1 | 61 | −34 | 0.8 |
| A2 | 60 | −35 | 0 |
| A3 | 62 | −32 | 1.3 |
| A4 | 61 | −39 | 1.7 |
| A5 | 61 | −36 | 1.1 |
| A6 | 62 | −39 | 1.2 |
| A7 | 60 | −37 | 1.6 |
| A8 | 59 | −36 | 1.7 |

TABLE 5b
Results of colorimetry for test paint tinted
with Permanent Red FGR 70 pigment paste.

| | Colour | | |
|---|---|---|---|
| Dispersing additive | strength F | a* | delta E |
| A1 | 38 | 33 | 0.9 |
| A2 | 39 | 32 | 0.8 |
| A3 | 37 | 34 | 0.6 |
| A4 | 40 | 30 | 0.7 |
| A5 | 37 | 31 | 0.6 |
| A6 | 38 | 34 | 0.8 |
| A7 | 39 | 33 | 0.7 |
| A8 | 37 | 31 | 0.9 |

TABLE 5c
Results of colorimetry for test paint tinted
with Bayferrrox 120 M pigment paste.

| | Colour | | |
|---|---|---|---|
| Dispersing additive | strength F | a* | delta E |
| A1 | 55 | 16 | 0.8 |
| A2 | 59 | 18 | 0.7 |
| A3 | 54 | 15 | 0.9 |
| A4 | 57 | 17 | 0.7 |
| A5 | 58 | 17 | 0.7 |
| A6 | 59 | 18 | 0.8 |
| A7 | 57 | 16 | 0.9 |
| A8 | 55 | 18 | 0.8 |

The results set out in Tables 3a to 3c and 5a to 5c show that the compounds of the invention are suitable for producing pigment pastes and for tinting white base paints.

### Example 4

### Performance Tests

For the performance investigations described below, esters A1 to A8 were diluted to a total solids content of 30% by weight with dilute aqueous 25% strength by weight potassium hydroxide solution, and this mixture was used as dispersing additive. Comparative additives used were Tego Dispers 715 W (solution of a sodium polyacrylate, Evonik Tego GmbH), identified below as B1, Tego Dispers 740 W (fatty acid ethoxylate, Evonik Tego GmbH), identified below as B2, and Hydropalat 34 (hydrophobic ammonium copolymer, Cognis), identified below as B3.

### Example 4.1

### Snail Trails

The test for formation of snail trails was carried out by drawdown of the paint, as white paint or as tinted paint, onto a glass plate, using a 300 μm four-way coating bar. This drawdown was dried at 50° C. for 24 hours. Then 50 ml of water were applied to the coating dropwise at 2.5 ml/min, at an angle of 45° C., using a metering system (peristaltic pump SP 041, Otto Huber GmbH, Böttingen). Solids selected for Examples 4.1.1 and 4.1.2 were commercial white pigments (Kronos 2310, Kronos, and Hombitan R 611, Sachtleben). The formation of shiny areas (snail trails) was then assessed optically.

### Example 4.1.1

### Snail Trails on a Silicone Resin Masonry Paint

The formula constituents 1 to 13 in accordance with the formula set out in Table 6 were introduced into the 1 l pot of a dissolver (Dispermat CV2-SiP, VMA Getzmann GmbH, D-51580 Reichshof). This was followed by dispersion with 300 g of glass beads at 2500 revolutions per minute for 30 minutes. After dispersion had taken place, the formula constituents 14 to 17 were stirred in at 2500 revolutions per minute for 15 minutes. The total mass of the formula constituents 1 to 17 was 300 g. The glass beads were then separated from the masonry paint by means of a sieve (E-D-Schnellsieb 400μ, cotton mesh, medium, from Erich Drehkopf GmbH).

TABLE 6
Composition of the silicone resin masonry paint

| Constituent | Raw material | % by weight |
|---|---|---|
| 1 | Water | 26.73 |
| 2 | Walocel XM 6000 PV 1 | 0.31 |
| 3 | TEGO ® Foamex 855 | 0.21 |
| 4 | Acticide MBS | 0.16 |
| 5 | Calgon N | 0.05 |
| 6 | Dispersing additive*⁾ | 0.12 |
| 7 | AMP 90 | 0.10 |
| 8 | Kronos 2310 | 12.98 |
| 9 | Socal P 3 | 10.38 |
| 10 | Omyacarb 5 | 15.58 |
| 11 | Omyacarb 2 | 10.38 |
| 12 | Mica TG | 3.12 |
| 13 | Sipernat ® 820 A | 2.08 |
| 14 | Phobe 1650 | 3.63 |
| 15 | Dowanol DPnB | 1.04 |
| 16 | Mowilith LDM 7717 | 12.46 |
| 17 | Rheolate 278 | 0.67 |
| | Total | 100.00 |

^{*)}Amount of dispersing additive used, based on active ingredient

The result of the optical assessment of Example 4.1.1 can be taken from Table 7.

TABLE 7
Result of Example 4.1.1

| Dispersing additive | Snail trails |
|---|---|
| A1 | no trails |
| A2 | |
| A3 | |
| A4 | |
| A5 | |
| A6 | |
| A7 | |
| A8 | |
| B1 | visible trails |
| B2 | visible trails |
| B3 | visible trails |

### Example 4.1.2

### Snail Trails on an Exterior Emulsion Paint

The formula constituents 1 to 14 in accordance with the formula set out in Table 8 were introduced into the 1 l pot of a dissolver (Dispermat CV2-SiP, VMA Getzmann GmbH, D-51580 Reichshof). This was followed by dispersion with 300 g of glass beads at 2500 revolutions per minute for 30 minutes. After dispersion had taken place, the formula constituent 15 was stirred in at 2500 revolutions per minute and the mixture was stirred further for 15 minutes. The total mass of the formula constituents 1 to 15 was 300 g. The glass beads were then separated from the exterior emulsion paint by means of a sieve (E-D-Schnellsieb 400μ, cotton mesh, medium, from Erich Drehkopf GmbH).

TABLE 8
Composition of the exterior emulsion paint

| Number | Raw material | % by weight |
|---|---|---|
| 1 | Water | 15.34 |
| 2 | Acticide MBS | 0.20 |
| 3 | Dispersing additive*⁾ | 0.12 |
| 4 | Calgon N | 0.20 |
| 5 | TEGO ® Foamex 810 | 0.10 |
| 6 | Hombitan R 611 | 22.27 |
| 7 | Omyacarb 5 GU | 14.85 |
| 8 | China Clay Pole Star 200 P | 4.95 |
| 9 | Micro Talc AT 1 | 2.48 |
| 10 | Tylose MH 30000 YP2 | 0.25 |
| 11 | Butyldiglycol acetate | 0.74 |
| 12 | White spirit | 0.74 |
| 13 | Aqueous ammonia (25% strength) | 0.20 |
| 14 | TEGO ® Foamex 810 | 0.15 |
| 15 | Mowilith LDM 7717 | 37.13 |
| | Total | 100.00 |

*⁾Amount of dispersing additive used, based on active ingredient

The result of the optical assessment of Example 4.1.2 can be taken from Table 9.

TABLE 9
Result of Example 4.1.2

| Dispersing additive | Snail trails |
|---|---|
| A1 | no trails |
| A2 | |
| A3 | |
| A4 | |
| A5 | |
| A6 | |
| A7 | |
| A8 | |
| B1 | visible trails |
| B2 | visible trails |
| B3 | visible trails |

On the basis of the test results reproduced in Tables 7 and 9, it is apparent that, through the use of compounds of the invention, it is possible to prevent the formation of snail trails.

### Example 4.2

### Water Swellability

The aqueous exterior emulsion paint from Example 4.1.2, Table 8, was used. The paint was applied to a glass plate, using a 300 μm four-way coating bar. This was followed by forced drying at 50° C. for 24 hours. The bar drawdowns were subsequently stored at room temperature (23° C.) for 24 hours, after which 0.3 ml of water was applied to the dried paint film, using a pipette. The drops of water were covered with a bullseye, and the time taken for water swelling to be visually perceptible was recorded. The results of this test are reproduced in Table 10.

TABLE 10
Result of Example 4.2

| | Water swellability |
|---|---|
| Dispersing additive | 24 h RT |
| A1 | swollen after 40 min |
| A2 | |
| A3 | |
| A4 | |
| A5 | |
| A6 | |
| A7 | |
| A8 | |
| B1 | swollen after 30 min |
| B2 | |
| B3 | |

On the basis of the test results reproduced in Table 10, it is evident that the use of compounds of the invention makes it possible to retard the water swellability.

### Example 4.3

### Wet Abrasion Resistance

The aqueous exterior emulsion paint from Example 4.1.2, Table 8, was used. The paint was applied to black Leneta sheets, using a 300 μm four-way coating bar. After a drying time of 14 days at 40° C., the test for wet abrasion resistance was carried out in accordance with the standard EN ISO 11998. The results of this test are reproduced in Table 11.

TABLE 11
Result of Example 4.3

| Dispersing additive | Wet abrasion (μm) | Class |
|---|---|---|
| A1 | 3.9 | 1 |
| A2 | 3.6 | 1 |
| A3 | 3.7 | 1 |
| A4 | 4.1 | 1 |
| A5 | 4.0 | 1 |
| A6 | 3.9 | 1 |
| A7 | 2.8 | 1 |
| A8 | 3.1 | 1 |
| B1 | 6.7 | 2 |
| B2 | 5.2 | 2 |
| B3 | 5.3 | 2 |

On the basis of the test results reproduced in Table 11, it is evident that the wet abrasion resistance can be improved over the prior art by using the compounds of the invention.

Having thus described in detail various embodiments of the present invention, it is to be understood that the invention defined by the above paragraphs is not to be limited to particular details set forth in the above description as many apparent variations thereof are possible without departing from the spirit or scope of the present invention.

1. Compounds liquid at a temperature of 20° C. and a pressure of 101325 Pa and of the general formula (I)
[R—O(SO)ₐ(EO)_{b}(CH₂CHCH₃O)_{c}(BO)_{d}]ₓ—[PO—(OH)₃₋ₓ]_{y}—R⁴_{z} (I),
or liquid mixtures consisting of compounds of the formula (I),
where
R= 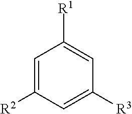
R¹=bond to the unit —O(SO)ₐ(EO)_{b}(CH₂CHCH₃O)_{c}(BO)_{d}—,
R²=identically or differently, H or —O(SO)ₐ(EO)_{b}(CH₂CHCH₃O)_{c}(BO)_{d}—[PO—(OH)_{2-x′}(R⁵)_{x′}]_{y′}—R⁴_{z′},
R³=identically or differently, saturated or unsaturated aliphatic hydrocarbon radical having 15 carbon atoms and 25 to 31 hydrogen atoms,
R⁴=identically or differently, H, M⁺ or alkyl having 1 to 3 C atoms,
R⁵=organic radical,
R⁶=identically or differently H or M⁺,
M⁺=metal or semi-metal cation,
SO=styrene oxide,
EO=ethylene oxide,
BO=butylene oxide, and
a=0 to 3,
b=0 to 100,
c=0 to 20,
d=0 to 3,
x=1 to 3,
y=0 or 1,
z=0 or 1,
y=0 or 1,
z′=0 or 1, and
x′=0 to 2,
with the proviso that y+z is =1, that when z=1, also x is =1, that y+z=1, that when z′=1, also x′ is =1, that when a, c and d are =0, b is from 1 to 12, that when c or d is other than 0, one of the other indices a to d is likewise other than 0, and that the sum a+b+c+d is greater than 3.

2. Compounds according to claim 1, characterized in that R² is =H, y is =1 and z is =0.

3. Compounds according to claim 1, characterized in that the units denoted with the indices a, b, c and/or d are arranged blockwise.

4. Compounds according to claim 1, characterized in that the unit which is the furthest away from the radical R, and which has a bond to the phosphorus or to R⁴, is an ethylene oxide unit.

5. Process for preparing compounds according to claim 1, characterized in that it comprises the steps of
A) activating a starter compound containing OH groups with a suitable acidic, basic or DMC catalyst,
B) reacting the compounds obtained in step A) with aliphatic and/or aromatic alkylene oxides, the aliphatic and/or aromatic alkylene oxides being used in molar amounts such that the indices a, b, c and d indicated in formula (I) are obtained,
C) optionally reacting the compound obtained in step B) with a phosphorus compound which forms phosphoric esters, and
D) optionally reacting the compound obtained in step C) with a neutralizing agent.

6. Process according to claim 5, characterized in that in step B) the reaction of the different aliphatic and/or aromatic alkylene oxides takes place in succession.

7. Process according to claim 5, characterized in that step C) is carried out and polyphosphoric acid (P₂O₅ in solution in H₃PO₄) is used as phosphorus compound.

8. Process according to claim 7, characterized in that 0.5 mol of P₂O₅ is used per mol of OH groups.

9. The process according to claim 6, wherein step C) is carried out and polyphosphoric acid (P₂O₅ in solution in H₃PO₄) is used as phosphorus compound and 0.5 mol of P₂O₅ is used per mol of OH groups.

10. Compositions comprising at least one compound according to claim 1.

11. Compositions according to claim 9, characterized in that the composition also contains water.

12. Composition according to claim 10, characterized in that the composition comprises at least one pigment.

13. A method of dispersing and stabilizing aqueous pigment pastes, paints, printing inks, printing varnishes or coating materials which comprises adding a compound of claim 1 as an additive to said aqueous pigment pastes, paints or printing inks.

14. The method of claim 12, wherein the pastes are binder-containing or binder-free pigment pastes.

15. The method of claim 12, wherein the units denoted with the indices a, b, c and/or d are arranged blockwise and the unit which is the furthest away from the radical R, and which has a bond to the phosphorus or to R⁴, is an ethylene oxide unit.

16. The compounds of claim 1, wherein b is at least 1 and with the proviso that y+z is =1, that when z=1, also x is =1, that y′+x′=1, that when z′=1, also x′ is =1, that when a, c and d are =0, b is from 6 to 10, that when c or d is other than 0, one of the other indices a to d is likewise other than 0, and that the sum a+b+c+d is greater than 3.

17. The compounds according to claim 2, wherein the units denoted with the indices a, b, c and/or d are arranged blockwise and the unit which is the furthest away from the radical R, and which has a bond to the phosphorus or to R⁴, is an ethylene oxide unit.
